(19) United States
(12) Patent Application Publication
(10) Pub. No.: US 2007/0090845 A1
(43) Pub. Date: Apr. 26, 2007

(54) METHOD AND APPARATUS FOR BATTERY TESTING USING A SINGLE MICROPROCESSOR PORT

(75) Inventors: David Mole, Medford, NY (US); Lance Weston,, East Northport, NY (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., MORRISTOWN, NJ (US)

(21) Appl. No.: 11/163,337

(22) Filed: Oct. 14, 2005

(51) Int. Cl. G01N 27/416

(52) U.S. Cl. 324/433

(57) ABSTRACT

A system for recharging and testing a rechargeable battery having first and second terminals which includes a microprocessor having at least a first port; a charger coupled to the first port and a connector for attachment to one of the terminals of the associated battery; and a comparator coupled to the charger and to the first port. The comparator compares a voltage at the first terminal of the associated battery and a reference voltage and produces respective first and second outputs. The first output is produced when the voltage at the first terminal is below a first predetermined value and the second output is produced when the voltage at the first terminal is above a second predetermined value. The charger charges the battery in response to the first output and not charging the battery in response to the second output. Other embodiments of the present invention include the method for recharging and testing a rechargeable battery having first and second terminals which includes providing a microprocessor having at least a first port; providing a battery charger coupled to the first port and a connector for attachment to one of the terminals of the associated battery; providing a comparator coupled to the charger and to the first port, comparing a voltage at the first terminal of the battery and a reference voltage with the comparator, producing respective first and second outputs from the comparator namely, producing a first output when the voltage at the first terminal is below a first predetermined value, producing a second output when the voltage at the first terminal is above a second predetermined value, and charging the battery in response to the first output and not charging the battery in response to the second output. In some embodiments of the method the step of providing a microprocessor includes providing a microprocessor that is part of a microcontroller. The method step of providing a microprocessor may alternatively further include providing random access memory. a data bus, ROM, a clock and an I/O control unit.

### BACKGROUND OF THE INVENTION

The invention relates to interfacing microcontrollers and microprocessors and particularly to testing and charging rechargeable batteries utilizing a single bidirectional port of such devices. Microcontrollers, also known as a “computer on a chip” or “MCU”, are single chip devices that contain a processor, RAM, ROM, clock and I/O control unit. Hundreds of millions of them are used each year for a myriad of applications from automobiles to toys. A wide variety of electronic devices, ranging from small gadgets and home equipment control to car electronics now use microcontrollers and the assemblies utilize batteries to provide electric power. The measurement of the battery charge status and recharging of the battery is essential to insure continued operation of the assembly. While the present invention has application to many of these devices, those skilled in the art will recognize that the present invention has particular application in the field of security systems for protecting residential and commercial buildings and facilities and particularly to battery supervised security system alarm panels.

### SUMMARY OF THE INVENTION

It is a general object to the present invention to maximize the possible resources of a microprocessor or microcontroller including microprocessors and microcontrollers installed in a security system panel. Stated another way, it is an object of the present invention to minimize the utilization of the available resources of a given microprocessor or microcontroller to accomplish a specific task.

It is also object of the present invention to use a single microprocessor or microcontroller port to output battery test and input battery pass/fail.

It is now been found that these in the other objects of the invention may be attained in a system for recharging and testing a rechargeable battery having first and second terminals which includes a microprocessor having at least a first port; a charger coupled to the first port and a connector for attachment to one of the terminals of the associated battery; and a comparator coupled to the charger and to the first port. The comparator compares a voltage at the first terminal of the associated battery and a reference voltage and produces respective first and second outputs. The first output is produced when the voltage at the first terminal is below a first predetermined value and the second output is produced when the voltage at the first terminal is above a second predetermined value. The charger charges the battery in response to the first output and not charging the battery in response to the second output.

In some embodiments of the system the microprocessor is part of a microcontroller. Alternatively, the microprocessor may be a discrete device and the system further includes associated random access memory and a data bus. Embodiments of the latter type may further include a RAM, ROM, clock and I/O control unit.

The system in accordance with the present invention may be a subsystem of a security system. In other embodiments the system accords will present invention may be a subsystem of a consumer product or some other system. The microprocessor is preferably fast enough to respond to changes in the output of the comparator. The charger may be a variable voltage charger.

Other embodiments of the present invention include the method for recharging and testing a rechargeable battery having first and second terminals which includes providing a microprocessor having at least a first port; providing a battery charger coupled to the first port and a connector for attachment to one of the terminals of the associated battery; providing a comparator coupled to the charger and to the first port, comparing a voltage at the first terminal of the battery and a reference voltage with the comparator, producing respective first and second outputs from the comparator namely, producing a first output when the voltage at the first terminal is below a first predetermined value, producing a second output when the voltage at the first terminal is above a second predetermined value, and charging the battery in response to the first output and not charging the battery in response to the second output.

In some embodiments of the method the step of providing a microprocessor includes providing a microprocessor that is part of a microcontroller. The method step of providing a microprocessor may alternatively further include providing random access memory. a data bus, ROM, a clock and an I/O control unit.

The method may further include utilizing the method in a security system, a consumer product or some other system. Preferably, the step of providing a microprocessor further includes providing a microprocessor that is fast enough to respond to changes in the output of the comparator that is provided in the method. The step of providing a charger may include providing a variable voltage charger.

### BRIEF DESCRIPTION OF A DRAWING

The invention will be better understood by reference to the accompanying drawing in which:

FIG. 1 is a schematic drawing of a prior art utilizing a first microprocessor port for monitoring the charge status of a battery and a second microprocessor port for charging the battery.

FIG. 2 is a schematic and drawing of the method and apparatus in accordance with the present method and apparatus for both monitoring the charge status of a battery and charging the battery with a single microprocessor port.

FIG. 3 is a more detailed schematic drawing which illustrates in greater detail the method and apparatus as shown in FIG. 2.

FIG. 4 is a diagrammatic view of the system in accordance with the present invention and illustrated in FIGS. 2 and 3 and a larger system such as a security system, medical system, telemetry system, space travel system and the like.

### DESCRIPTION OF THE PREFERRED EMBODIMENTS

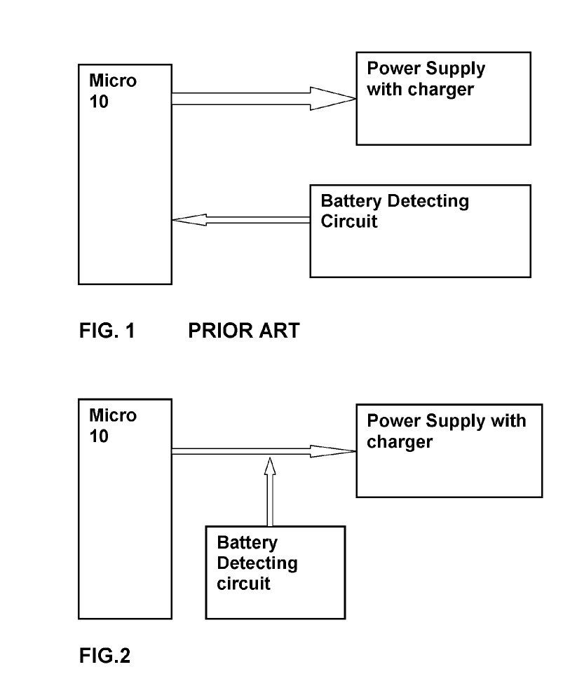

In the prior art method and apparatus as illustrated in FIG. 1 a first port is used to control a power supply and charger assembly is connected to an associated battery. A second port is connected to a detecting circuit that detects the output voltage of an associated battery. As described above, this prior art approach does not maximize the utilization of the processor.

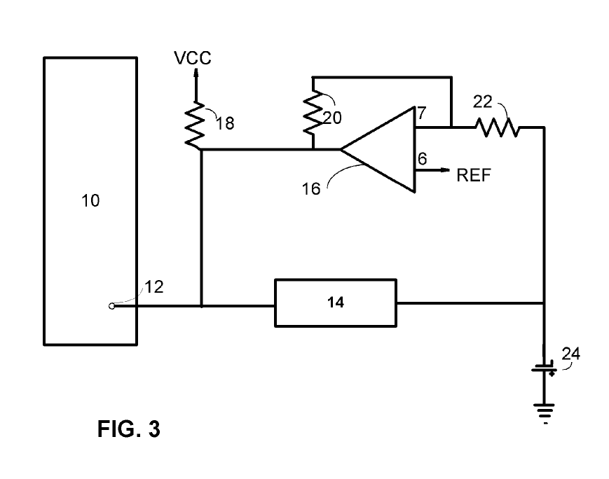

As shown in FIG. 2, a single port of the processor is coupled to both a power supply and charger and a battery detecting circuit. This apparatus and method is shown in more detail in FIG. 3.

The method and apparatus in accordance with present invention tests the integrity of a battery on an alarm system. This method and apparatus requires the reduction of the charging voltage for the battery below the point that would conventionally be indicative that the battery bad or missing. This allows measurement of the output voltage independently of the masking effect of the battery charger.

The circuit shown in FIG. 3 includes a processor 10 having a port 12 that is connected a comparator 16 such as an LM339 quad voltage comparator. The processor 10 in a preferred embodiment is an Atmel AT87C51RD2 microcontroller. Those skilled in the art will recognize that this microcontroller includes a processor, RAM, ROM, clock and an I/O control unit. Other microprocessors that support bi-directional functionality on a single port pin may also be used. An additional requirement of the processor is that it must be fast enough to detect a transition in the output of the comparator 16.

The circuit also includes a variable voltage battery charger 14 of conventional design. In a preferred embodiment the veritable voltage battery charger 14 is of a type used in Honeywell alarm panels. Variable voltage battery charger circuits are readily available on the Internet. One such example may be found at http://www.elecdesign.com/Articles/Index.cfm?AD=1&ArticleID=1823. The components described above are conventional parts of alarm panels used in the security industry. The single connection to a single port of a single processor is not conventional.

The comparator 14 is a device which compares two voltages and switches its output to indicate which is larger. A dedicated voltage comparator chip, like the LM339, is designed to interface directly to digital logic (such as TTL or CMOS), since the output is a binary state, and is often used to interface real world signals to digital circuitry. The LM339 accomplishes this with an open-collector output. When the inverting input is higher, the output of the comparator is connected to the negative power supply. When the non-inverting input is higher, the output is floating (has a very high impedance to ground). With a pull-up resistor and a 0 to +5V power supply, for instance, the output takes on the voltages 0 or +5, and can be interfaced to TTL logic.

The port pin 12 is normally low (0 volts in a preferred embodiment). This output causes the variable voltage battery charger 14 at the optimal battery charging voltage. In a preferred embodiment this is 13.8 volts. In battery test mode the port 12 is brought high (5 volts in a preferred embodiment) to cause the battery charger 14 to reduce the battery charger voltage to 10.5 volts. The comparator 16 compares the voltage provided by the battery 24 through the resistor 22 to pin 7 of the comparator to a reference (2.5 volts in a preferred embodiment) connected to pin 6 of the comparator 16. The purpose of the reference voltage is merely to prevent oscillation of the output of the comparator 16. VCC in the preferred embodiment is 5 volts. The circuit is designed so that the output of the comparator 16 will fall to zero if the voltage at the battery is less than 11 volts.

Accordingly, in battery test mode with the battery charger voltage output at 10.5 volts, the voltage at the battery terminal will not exceed 10.5 volts unless the battery has an output that is greater than 10.5 volts. If the voltage is above 10.5 volts but below 11 volts the output of the comparator 16 will fall to zero.

The circuit is constructed so that the variable voltage battery charger 14 will begin charging any preferred voltage of 13.8 volts when the output of the comparator 16 falls to zero. If the voltage at the battery is 11 volts or more the output of the comparator 16 will rise to 1 and the battery charger 14 will be turned off.

In normal operation of the system, after a period of charging a functional battery 24, the charger 14 will charge the battery 24 to a voltage of 11 volts plus the hysterisis voltage and the comparator output to the micro will go to 1 and the battery charger 14 will be turned off.

Although the present invention has particular application to use with microcontrollers, those skilled in the art will recognize that each microcontroller includes a processor. Thus, the term “microcontroller” as used in the claims will be understood to encompass devices having a processor, RAM, ROM, clock and I/O control unit on a chip as well as devices in which the individual parts may be discrete devices.

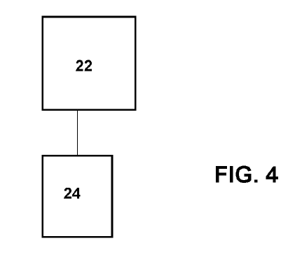

Similarly, while the present invention has particular application in a security system for protecting a building or an area, those skilled in the art will recognize a vast array of other applications. Any system that uses a rechargeable battery and a microcontroller or a microprocessor could potentially use the method and apparatus of the present invention. This includes, but is not limited to medical apparatus such as apparatus that records and transmits data regarding a patient and telemetry equipment that transmits real-time data on critical processes. The use of microcontrollers has increased exponentially. Many such applications use rechargeable batteries and such systems may well benefit from the apparatus and method in accordance with the present invention. This concept is illustrated diagrammatically in FIG. 4 which illustrates diagrammatically the relationship between the system 20 in accordance with the present invention (as shown in FIGS. 2 and 3) and a larger system 22. The larger system 22 may be a security system, a medical system, a telemetry system or any other system that utilizes a microprocessor or a microcontroller and a rechargeable battery.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompass other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for recharging and testing a rechargeable battery having first and second terminals which comprises:
a microprocessor having at least a first port;
a charger coupled to said first port and a connector for attachment to one of the terminals of the associated battery;
a comparator coupled to said charger and to said first port, said comparator comparing a voltage at said first terminal of the associated battery and a reference voltage, said comparator producing respective first and second outputs, said first output being produced when the voltage at the first terminal is below a first predetermined value, said second output being produced when the voltage at the first terminal is above a second predetermined value, said charger charging the battery in response to said first output and not charging the battery in response to said second output.

2. The system as described in claim 1 wherein said microprocessor is part of a microcontroller.

3. The system as described in claim 1 wherein said microprocessor is a discrete device and said system further includes associated random access memory and a data bus.

4. The system as described in claim 1 wherein said microprocessor is a discrete device and said system further includes a RAM, ROM, clock and I/O control unit.

5. The system as described in claim 1 wherein said system is subsystem of a security system.

6. The system as described in claim 1 wherein said system is a subsystem of a consumer product.

7. The system as described in claim 1 wherein said system is a subsystem of another system.

8. The system as described in claim 1 wherein said microprocessor is fast enough to respond to changes in the output of said comparator.

9. The system as described in claim 1 wherein said charger is a variable voltage charger.

10. A method for recharging and testing a rechargeable battery having first and second terminals which comprises:
providing a microprocessor having at least a first port;
providing a battery charger coupled to the first port and a connector for attachment to one of the terminals of the associated battery;
providing a comparator coupled to the battery charger and to the first port,
comparing a voltage at the first terminal of the battery and a reference voltage with the comparator,
producing respective first and second outputs from the comparator namely, producing a first output when the voltage at the first terminal is below a first predetermined value,
producing a second output when the voltage at the first terminal is above a second predetermined value,
charging the battery in response to the first output and not charging the battery in response to the second output.

11. The method as described in claim 10 wherein the step of providing a microprocessor includes providing a microprocessor that is part of a microcontroller.

12. The method as described in claim 10 wherein the step of providing a microprocessor further includes providing random access memory and a data bus.

13. The method as described in claim 10 wherein the step of providing a microprocessor further includes providing a RAM, ROM, clock and an I/O control unit.

14. The method as described in claim 10 further includes utilizing the method in a security system.

15. The method as described in claim 10 further includes utilizing the method in a consumer product.

16. The method as described in claim 10 further includes utilizing the method in another system.

17. The method as described in claim 10 wherein the step of providing a microprocessor further includes providing a microprocessor that is fast enough to respond to changes in the output of the comparator that is provided in the method.

18. The method as described in claim 10 wherein the step of providing a charger includes providing a variable voltage battery charger.
